(19) United States
(12) Patent Application Publication
(10) Pub. No.: US 2020/0234018 A1
(43) Pub. Date: Jul. 23, 2020

(54) Modular Camera Apparatus and Method for Optical Detection

(71) Applicant: SICK AG, Waldkirch (DE)

(72) Inventors: Florian SCHNEIDER, Waldkirch (DE); Romain MÜLLER, Waldkirch (DE)

(21) Appl. No.: 16/747,813

(22) Filed: Jan. 21, 2020

(30) Foreign Application Priority Data
Jan. 22, 2019 (DE) 102019101490.5

(51) Int. Cl. G06K 7/14; H04N 13/282; H04N 5/232

(52) U.S. Cl. CPC G06K 7/1439; H04N 5/23299; H04N 13/282

(57) ABSTRACT

A modular camera apparatus is provided having a common control and evaluation unit and having at least one camera module that has a reception optics and an image sensor that determine a module viewing zone of the camera module, wherein the module viewing zones together produce a monitored zone of the camera apparatus. The monitored zone is here adaptable by a common setting of the module viewing zones.

The invention relates to a modular camera apparatus having a common control and evaluation unit and having at least one camera module that has a reception optics and an image sensor that determine a module viewing zone of the camera module, wherein the module viewing zones together produce a monitored zone of the camera apparatus. The invention further relates to a method for optical detection of a monitored zone that is composed of the module viewing zones of a plurality of camera modules that are each determined by a reception optics and an image sensor of the camera modules.

Cameras are used in a variety of ways in industrial applications to automatically detect object properties, for example for the inspection or for the measurement of objects. In this respect, images of the object are recorded and are evaluated in accordance with the task by image processing methods. A further use of cameras is the reading of codes. Objects with the codes located thereon are recorded with the aid of an image sensor, the code regions are identified in the images, and are then decoded. Camera-based code readers also cope without problem with different code types than one-dimensional barcodes which also have a two-dimensional structure like a matrix code and provide more information. The automatic detection of the text of printed addresses, (optical character recognition, OCR) or of handwriting is also a reading of codes in principle. Typical areas of use of code readers are supermarket cash registers, automatic parcel identification, sorting of mail shipments, baggage handling at airports, and other logistic applications.

A frequent detection situation is the installation of the camera above a conveyor belt. The camera records images during the relative movement of the object stream on the conveyor belt and instigates further processing steps in dependence on the object properties acquired. Such processing steps comprise, for example, the further processing adapted to the specific object at a machine which acts on the conveyed objects or a change to the object stream in that specific objects are expelled from the object stream within the framework of a quality control or the object stream is sorted into a plurality of partial object streams. If the camera is a camera-based code reader, the objects are identified with reference to the affixed codes for a correct sorting or for similar processing steps.

The respective uses differ in their demands, for example with respect to the required resolutions, working distances, recording frequencies, and the like. Different instrument variants have previously been offered for this purpose that clearly differ from one another and that are produced in a separate product development process. A platform approach is possible on the software side here, but there are hardly any synergies for the hardware, which results in long development times and a high resource effort. This is due to the fact that a plurality of steps are required for the respective hardware adaptation: selecting and implementing a suitable image sensor; finding a suitable objective or producing it in an in-house design; comparable steps for the light source and optics of the lighting, developing the associated electronics and implementing on a circuit board; optimizing temperature management; and finally also designing and producing a housing.

It is known to connect a plurality of cameras to form a camera array. US 2011/0109748 A1 is an example of this. However, this does not yet produce a sensor suitable for industry.

EP 2 546 776 B1 discloses a camera based code reader that consists of a plurality of camera arrays arranged next to one another. Line scan cameras, however, still do not allow sufficient degrees of freedom for a modular concept.

A 3D time of flight camera having a plurality of time of flight modules and one central control and evaluation unit is presented in DE 10 2017/107 903 A1. The phase based time of flight method used, however, makes very particular demands so that this cannot be simply generalized.

It is generally known to accommodate a plurality of modules in an extruded element as a housing, for instance for light grids or also, from U.S. Pat. No. 9,940,494 B2, for RFID readers to expand the detection zone. This does not relate to the actual sensor work and in particular not to the case of a camera.

DE 10 2014 114 506 A1 discloses a camera for inspection or identification that also generates a three-dimensional image of the object geometries. A modular approach or a particularly flexible adaptation to different conditions of use beyond this is not known.

It is therefore the object of the invention to provide a more flexible camera apparatus.

This object is satisfied by a modular camera apparatus and by a method for optical detection of a monitored zone in accordance with the respective independent claim. The camera apparatus comprises a plurality of camera modules each having an image sensor and a reception optics. The module viewing zone of each camera module is determined by the field of view of the reception optics and of the image sensor. The module viewing zones complement one another to form the monitored zone of the camera apparatus.

The invention starts from the basic idea of making the monitored zone adaptable. For this purpose, the individual module viewing zones are set together or in a coordinated manner. The field of view in total is thereby in particular increased or decreased in size by a more or less mutual viewing zone. The overlap can in turn be used for different purposes, for example a higher resolution, a faster recording frequency, or an expanded depth of field range. The adaptation of the module viewing zones can be understood as a one-time event in the sense of a suitable selection on the assembly of the camera apparatus from camera modules or on the setting up of the camera apparatus at the site of use, but also dynamically in the sense of a reaction by an actuator to the current detection situation.

The invention has the advantage that a scalable camera platform is produced. Comparatively simple camera apparatus for the most varied application demands can be set up. A substantial development effort for device variants can thereby be saved and the manufacturing costs are additionally reduced.

The camera module preferably has a tilting unit for changing the direction of view. The directions of view of the camera modules can thus be individually oriented. The control and evaluation unit provides a coordinated setting of the tilting direction. The module viewing zones thereby complement one another to form the respectively desired monitored zone, including overlapping zones.

The tilting unit preferably has a liquid lens or a voice coil actuator. A compact reception optics for adjusting module viewing zones is produced using a tiltable liquid lens or a voice coil actuator.

The image sensors of the camera modules are preferably arranged in a common plane. The alignment of the individual module viewing zones would in principle also be possible by arranging the image sensors on a suitably curved surface. The manufacture and setup of the camera apparatus are, however, substantially simplified with a planar arrangement. The module viewing zones can then be adapted by tilting.

The camera module preferably has a focus adjustment unit. The monitored zone is not only laterally determined by the zone from which light is received at all, but also by the depth of field range. For the desired information cannot be derived from a blurred image, for instance no code can be read. A focus adjustment can therefore also be understood as an adaptation of the module viewing zone. The control and evaluation unit in turn provides a coordinated, common setting of the focal positions. The focus adjustment unit can be configured together with the tilting unit, that is it can satisfy both functions. The examples of a liquid lens or voice coil actuator already named for the tilting unit are in particular suitable for this purpose.

The control and evaluation unit is preferably configured to set the module viewing zones and in particular their overlap in dependence on a focal position. The goal can be that no gaps are produced in the depth of field range set by the focal position. For this purpose, a greater tilt toward one another can be necessary with a closer focal position so that a certain overlap or at least a gap-free adjacent positioning of the module viewing zones is already achieved at the distance corresponding to the focal position. With a distant focal position, in contrast, there may by all means still be gaps between the module viewing zones for shorter distances since no sharp images are anyway recorded here. A small tilt toward one another is thereby sufficient; possibly even a tilt away from one another is conceivable to cover an even greater monitored zone.

The control and evaluation unit is preferably configured to set the module viewing zones in dependence on a geometry of an object to be detected. Object geometry preferably means a distance contour, that is the respective object distance from the camera apparatus beyond the object. The object geometry is preferably measured, but can also be based on specifications or assumptions. The module viewing zones are then aligned accordingly to detect the object geometry as completely and as exactly as possible. The focal position is preferably also set here. Different focal positions per camera module are conceivable here if the object geometry results in different distances in the respective module viewing zones.

The control and evaluation unit is preferably configured to detect three-dimensional images with the aid of the camera modules and to derive a working distance therefrom for which the module viewing zones are set. A 3D detection is possible, for example, in that the image data of at least two camera modules having an overlapping module viewing zone are evaluated using a stereoscopic process. A different embodiment uses special 3D camera modules in which a time of flight method is implemented, for example. If the three-dimensional image data are to be used for setting the module viewing zones, a fast image recording relative to the dynamics of the scenery is advantageous so that the settings are make in good time to thus still detect the desired image information.

The camera modules preferably form at least one linear arrangement that is connected to the control and evaluation unit in a serial connection. Such a linear arrangement enables a particular simple design. The signals for the control or conversely the image data or other output data are preferably guided through by the camera modules and only at least one end of the serial connection is connected to the control and evaluation unit.

The camera apparatus preferably has at least one illumination module. The monitored zone is illuminated thereby. In principle, a coordinated control is also conceivable for the illumination modules for forming a common illumination zone from module illumination zones analog to the camera modules. The illumination modules can equally form a linear arrangement similar to the described preferred embodiment for camera modules. Illumination modules for generating a structured illumination pattern are conceivable, for instance for an active stereoscopic process.

The camera apparatus preferably has at least one projection module. An illumination pattern is thus produced in the monitored zone that, unlike the illumination of an illumination module, does not support the detection of image data, but rather gives the user information. Examples include a target laser for marking the reading field of a code reader or status information that reports back a successful detection, for example.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

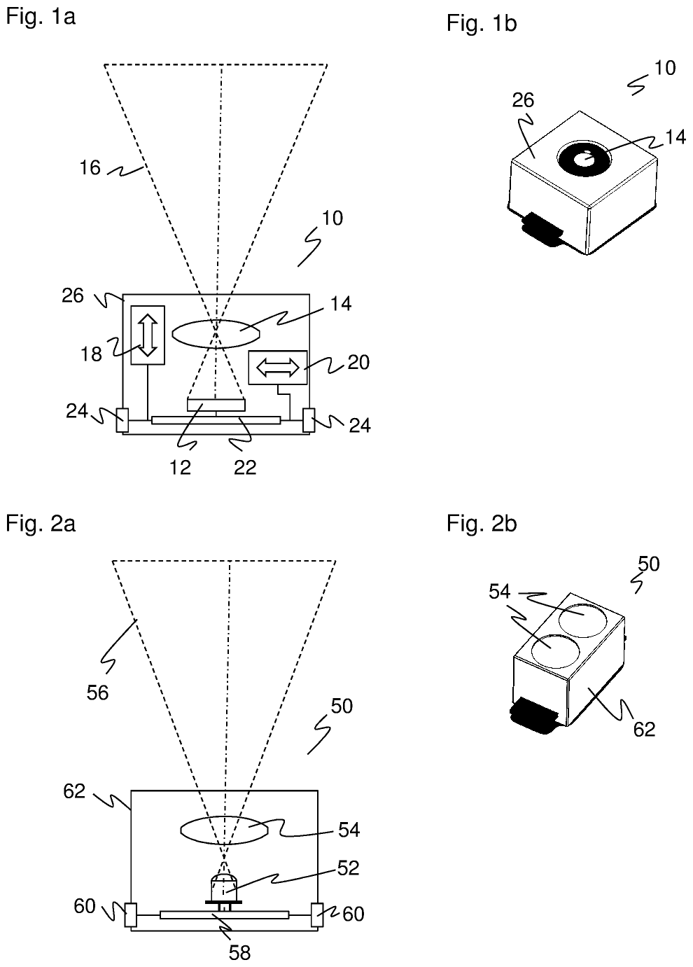

FIG. 1a a sectional view of a camera module;

FIG. 1b a three-dimensional view of a camera module;

FIG. 2a a sectional view of an illumination module;

FIG. 2b a three-dimensional view of an illumination module;

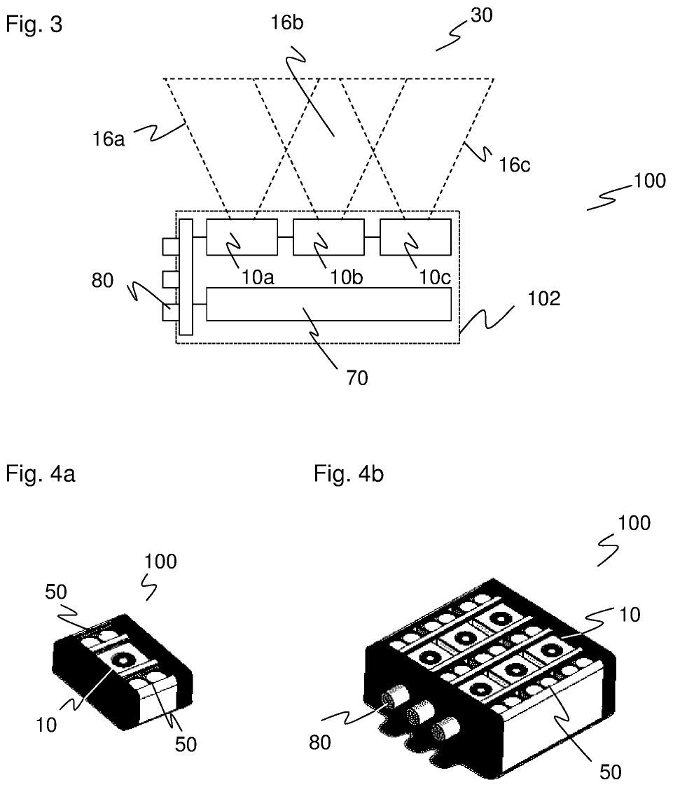

FIG. 3 a sectional view of a camera having three camera modules;

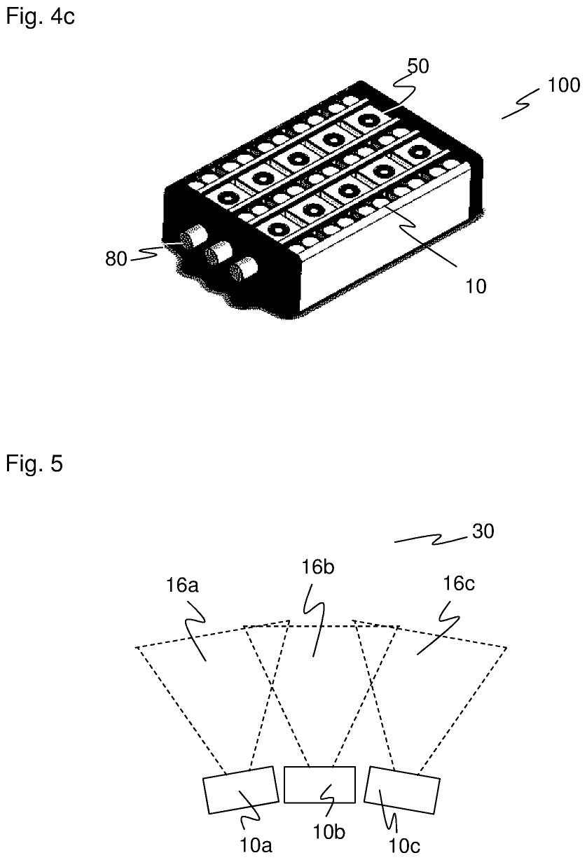

FIG. 4a a three-dimensional view of a camera having a camera module and two illumination modules;

FIG. 4b a three-dimensional view of a camera having six camera modules and nine illumination modules;

FIG. 4c a three-dimensional view of a camera having ten camera modules and fifteen illumination modules;

FIG. 5 a schematic view of three camera modules for explaining an arrangement on a curved surface:

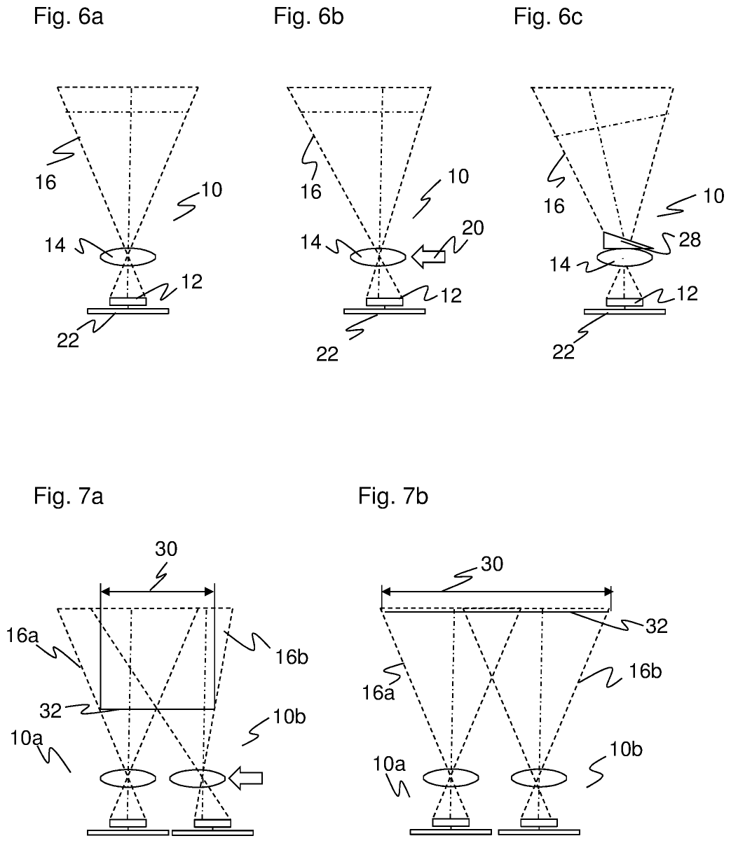

FIG. 6a a sectional view of a camera module without tilting for comparison;

FIG. 6b a sectional view of a camera module with tilting by shifting the lateral relative position of the reception optics and the image sensor;

FIG. 6c a sectional view of a camera module with tilting by an additional optical element;

FIG. 7a a sectional view of two camera modules of which one is tilted to increase the size of the overlap zone;

FIG. 7b a comparative view to FIG. 7a without tilting to increase the size of the monitored zone;

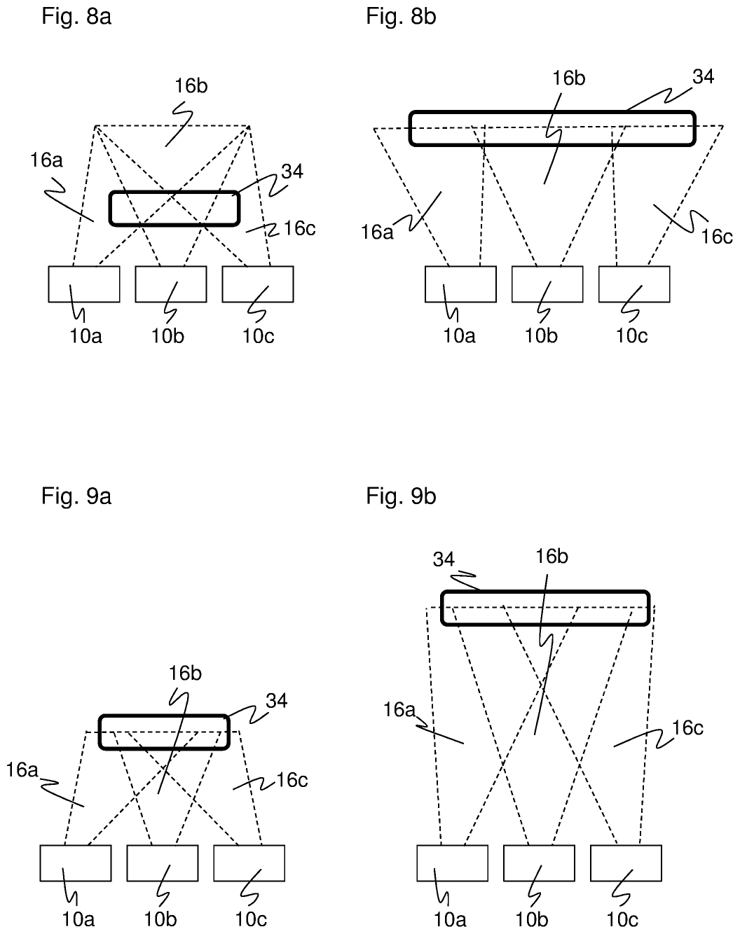

FIG. 8a a sectional view of three camera modules with a large mutual overlap for a closer focal position achieved by tilting;

FIG. 8b a sectional view similar to FIG. 8a, but now only with a different tilt for little overlap with a distance focal position;

FIG. 9a a sectional view of three camera modules with a setting of the tilt and the focal position on a near object; and

FIG. 9b a sectional view similar to FIG. 9a, but now only with a setting of the tilt and the focal position on a distant object.

FIG. 1a shows a schematic sectional view of a camera module 10. FIG. 1b is a supplementary exemplary 3D view. The camera module 10 has an image sensor 12 and a reception optics 14 that is here represented in a simplified manner by a simple lens. The image sensor 12 is preferably the same for a whole family of cameras in which camera modules 10 are used or it at least has the same connections (pinning) for a very simple replaceability. Variants such as monochrome, color, polarized, and the like are then also possible. Alternatively to standard image sensors, line scan cameras or event based image sensors can also be used.

The properties of the image sensor 12 and of the reception optics 14 and their arrangement determine a module viewing zone 16 of the camera module. Whereas the module viewing zone 16 generally designates the zone from which the image sensor 12 can receive and detect light, there is additionally the depth of field range as a further property of the module viewing zone 16. For most evaluations cannot be carried out with blurred image data.

A focus adjustment 18 that is only shown very schematically is therefore provided to change the depth of field range. Depending on the embodiment, the focus adjustment 18 can change the distance between the image sensor 12 and the reception optics 14 or can change the focal length of the reception optics 14 directly. An electronic focus adjustment 18 is to be preferred since a manual setting would be too complex for a plurality of camera modules 10.

A tilting unit 20 serves to laterally shift the module viewing zone 16. The reception optics 14 by no means has to be physically tilted for this purpose; the tilting unit 20 rather preferably comprises a suitable actuator, for example in the form of a voice coil actuator or a tiltable liquid lens. The focus adjustment 18 and the tilting unit 20 can also be formed together. In principle, the position of the image sensor 12 with respect to the reception optics 14 can be changed for the tilting; however, as a rule, this is the more laborious solution for construction reasons.

A pre-processing unit 22 of the camera module 10 is connected to the image sensor 12. Different evaluation modules are conceivable for this; for example an FPGA (field programmable gate array), a special AI chip, or a microcontroller. The pre-processing relates to work such as segmentation or filtering, in particular to a geometric correction using the intrinsic camera parameters that prepares an assembly of part images of individual camera modules 10 to a total image or generally to an image preparation that especially results in an improved reading result in code reading systems. An AI chip supports image evaluation processes with neural networks (CNNs, convolutional neural networks) and can carry out multi-dimensional multiplications almost in real time. The pre-processing unit 22 can, differing from the representation, be at least partly integrated on a chip together with the image sensor 12.

The camera module 10 communicates with other camera modules or with higher ranking electronics via electronic interfaces 24. FIG. 1a shows by way of example interfaces 24 at both sides for a preferred serial arrangement of a plurality of camera modules 10. The camera module 10 is accommodated in a housing 26.

FIG. 2a shows a schematic sectional view and FIG. 2b a supplementary exemplary 3D view of an illumination module 50. Illumination modules 50 can be combined with camera modules 10 to form a camera with active illumination. The basic design of an illumination module 50 is similar to that of a camera module 10. It comprises a light source 52, for example an LED or a laser, and an illumination optics 54. A module illumination zone 56 is thus produced. The module illumination zone 56 is fixed in the embodiment shown. A variable module illumination zone 56 having an actuator corresponding to the focus adjustment 18 and/or to the tilting unit 20 would, however, also be conceivable. A focusing is, for example, sensible when the illumination module 50 does not only produce brightness, but also a structured illumination pattern.

Analog to the pre-processing unit 22, an illumination control 58 is provided having an illumination driver and further possible functions such as storage of module properties, modulation of the light source 52, and the like. The illumination module 50 communicates with other modules or with higher ranking electronics via interfaces 60 and is surrounded by a housing 62. The three-dimensional view of FIG. 2b shows an embodiment in which an illumination module 50 has two light sources 52 and transmission optics 54, with this number to be understood as purely exemplary, but being intended to indicate that a plurality of light sources 52 per camera module 10 are frequently required.

FIG. 3 shows a sectional view of a camera 100 having three camera modules 10a-c. The inner structure of the camera modules 10a-c was presented in FIG. 10a and is here no longer shown for reasons of simplicity. The modular multi-camera concept naturally also permits a different number of camera modules 10a-c and a different arrangement than their linear one.

The respective module viewing zones 16a-c complement one another to form a monitored zone 30 of the camera 100. The adaptation of module viewing zones 16a-c to form different monitored zones 30 will be explained in more detail below with reference to FIGS. 6 to 9.

At least one illumination module 50, not shown here, can preferably belong to the front end of the camera 100. The camera modules 10a-c are supplemented by a processor module 70, also called a common control and evaluation unit, and by an interface module 80. The interface module 80 connects the camera modules 10a-c and optionally further modules such as illumination modules 50 to the process module 70 and moreover has interfaces of the camera 100 toward the outside. The processor module 70 communicates and cooperates with the pre-processing units 22 of the camera modules 10a-c.

A housing 102 of the camera 100 is preferably manufactured as an extruded element in a likewise modular housing concept to map the different device variants. Aluminum is a suitable material.

The plurality of camera modules 10a-c and the monitored zone 30 composed of their module viewing zones 16a-c can serve the most varied application demands. Some application examples for the scalable multi-camera 100 have been briefly named in the introduction, in particular inspection and measurement in an industrial environment and the reading of codes.

If module viewing zones 16a-c are arranged next to one another or strung together, the total field of view and thus the monitored zone 30 increase in size. In this respect, no overlaps or only slight overlaps preferably remain. It is conceivable to assembly the individual images of the camera modules 10a-c to a total image (image stitching). However, this is not absolutely necessary for some applications such as code reading. The data can rather then also be combined after a first decoder segmentation step or from a plurality of (partial) decoding processes.

A zone focus is possible since the focus positions of the camera modules 10a-c are individually settable. In this respect, there is not the conventional single focus position of the total camera 100, but camera modules 10a-c rather focus zone-wise on different distances in accordance with individual module viewing zones 16a-c. Scenery elements can thus also be recorded as sharp at very different distances outside the depth of field range of an individual camera module 10a-c. An example is the detection of objects or packets that run below the camera 10 next to one another on a conveyor belt and that can have very different heights.

A redundancy in the overlap zones of the module viewing zones 16a-c can be used in a variety of manners, for example to increase resolution, for an increased depth of field zone by complementary focus positions, or to increase the image recording rate.

If at least two camera modules 10a-c observe the same zone from their different perspectives, a 3D imaging in accordance with the principle of stereoscopy is also possible. An illumination module 50 is then preferably used that has a pattern generation element, for instance in the form of a diffractive optical element or a microlens field, and that illuminates the mutually observed zone with a structured pattern to ensure sufficient image features for the stereo correlation and thus the detection of a depth image that is as free of gaps as possible.

FIGS. 4a-c show some examples of device variants of the camera 100 with different module configurations in a three-dimensional view. Camera modules 10 and illumination modules 50 that are respectively of the same kind among one another are preferably used here so that no variants are required on a modular level.

In a very small embodiment in accordance with FIG. 4a, a camera module 10 is combined with two illumination modules 50. To save room here, the processor module 70 can be accommodated in a lateral end cap of the housing 102 instead of among the modules 10, 50. The interface module 80 is located in the other lateral end cap. The housing 102, preferably produced as an extruded element, can be varied in length to accommodate wide camera modules 10 and illumination modules 50.

FIG. 4b shows an embodiment of the camera 100 having six camera modules 10 and nine illumination modules 15. In this respect, as shown in FIG. 3, the modules 10, 50 can be pushed into a first plane and the processor module 70 into a second plane of the extruded module of the housing 102.

FIG. 4c shows an embodiment of the camera 100 having ten camera modules 10 and fifteen illumination modules 50. This corresponds to an extension of the embodiment in accordance with FIG. 4b.

The camera modules 10 are each arranged in a row next to one another. In FIGS. 4b and 4c there are two respective such rows or strands next to one another, with move rows also being possible for an even wider monitored zone 30. The illumination modules 50 also form such rows. The combination of camera modules 10 and illumination modules 50 in the same strand is conceivable, but technically more challenging. The interconnection and arrangement can anyway differ from the regular rows of FIGS. 4a-c.

The signals are each provided by the module 10, 50 arranged upstream in the row and are forwarded or channeled to the module 10, 50 arranged downstream. The signals reach the processor module 70 via the interface module 80. An additional interface map on the opposite side in the second end cap is not only possible for the smallest camera 100 of FIG. 4a.

The processor module 70 can be designed in different power classes or sizes for the respective camera 100. It is, however, also conceivable to continue the modular idea and to build up the respective processor module 70 from assembled submodules.

The interface module 80 and the processor module 70 or submodules thereof can be accommodated in any desired mixed forms among the modules 10, 50 or in the lateral end caps of the housing 102.

The mutual position of the module viewing zones 16a-c should not generally be determined in the camera 100 directly by the dimensions and distances of the camera modules 10a-c within the camera 100. The module viewing zones 16a-c vary when the direction of view of the camera modules 10a-c is tilted. A possibility of achieving this is the tilting of all the camera modules 10a-c or the accommodation of the camera modules 10a-c or at least of the image sensors 12 on a sphere.

This is illustrated in FIG. 5 where the lateral camera modules 10a,c are outwardly tilted by a curved support surface and a larger monitored zone 30 thereby results overall. Such an arrangement is, however, technically complex, inflexible, and no longer completely modular.

FIGS. 6a-c illustrate how an effective slanting of the camera modules 10 is also possible without a physical slanting. This has the great advantage that the contact surface can remain planar. The camera modules 10 accordingly remain physically aligned in parallel with one another; the image sensors 12 are disposed in a flat plane. The camera 10 can thus be manufactured a lot less expensively and more simply.

FIG. 6a first shows a perpendicular arrangement without a tilt as a reference. A tilt to the left is achieved in FIG. 6b in that the reception optics 14 is shifted to the left and the associated module viewing zone 16 is tilted to the left. The image sensor 12 could instead also be shifted to the right. In FIG. 6c, the tilt is achieved with an additional optical component 28, for example an optical wedge or a prism.

The tilt is preferably variable in that the tilting unit 20 is equipped with a corresponding actuator. An embodiment for this is a 3D voice coil actuator that permits a combination of a lens tilt and a lateral objective displacement in up to five degrees of freedom. Another possibility is offered by adaptive lenses, in particular liquid lenses, that cannot only be adjusted in focal length by additional electrodes, but are additionally also tiltable. The lateral movement of the image sensor 12 and/or reception optics 14 for the effective tilting of a camera module 10 should, however, not be precluded by such preferred implementations.

Some forms of the tilting of a camera module 10 result in a plane of focus that is no longer arranged in parallel. This is the case, for example, in FIG. 6c, but also in the camera modules 10a,c in FIG. 5. The slant restricts the total depth of field of the camera. The image sensor 12 can be slanted as a correction, preferably in a Scheimpflug arrangement. The depth of field can in particular represent a problem with large tilt angles.

The effective tilting of camera modules 10 and thus a shifting of module viewing zones 16 can be used to adapt the monitored zone 30. The camera modules 10 or their module viewing zones 16 are preferably aligned with the aid of the tilting unit 20 and optionally of the focus adjustment unit 18 such that a monitored zone 30 suitable for the application is produced in dependence on the focal position and on the object contour to be recorded.

FIGS. 7a-b illustrate this concept. FIG. 7a shows the situation for a focal position 32 that is very close with a tilted right camera module 10b. The module viewing zones 16a-b move closer together here. No overlap gaps thereby arise between the module viewing zones 16a-b at a distance of the near focal position 32.

With a far focal position 32 as in FIG. 7b, in contrast, the total field of view indicate by an arrow or the useful monitored zone 30 can be increased in size in that the tilt is at least partly canceled or even in that a tilt is set that is directed away from the other camera module 10a-b.

FIGS. 8a-b substantiate the concept for an example with now again three camera modules 10a-c. A tilt dependent on the set focal distance is carried out in the respective camera modules 10a-c with the aid of the tilting unit 20. In the example of FIGS. 8a-b, only the set focal position is known; in the example of FIGS. 9a-b subsequent thereto the object distance.

With the camera modules 10a-c arranged next to one another, there is a zone for short distances in which the module viewing zones 16a-c do not overlap, i.e. a detection gap. This is problematic for the recording of a correspondingly near object because it is not detected in part.

For a near focal position as in FIG. 8a, the outer camera modules 10a,c are therefore inwardly tilted in dependence on the focal position. The distance of the object 34 is intended not to be known in the case of FIGS. 8a-b; the set focal position and tilt therefore do not ideally agree with the position of the object 34. It is, however, achieved, that the module viewing zones 16a-c already overlap for shorter object distances. As long as therefore the object 34 is in a depth of field range corresponding to the focal position, it is also detected without gaps.

Alternatively, for a far focal position as in FIG. 8b, the tilt can also be canceled or the outer camera modules 10a,c are even outwardly tilted. A larger field of view is thereby set; a larger monitored zone 30 is therefore produced. The lack of overlap in the near zone is deliberately accepted; an object 34 located there would anyway only be detected in a very blurred manner due to the set far focal position.

FIGS. 9a-b illustrate the even more favorable case in which even the object distance is known. In a preferred embodiment in which the camera is mounted above a conveyor belt, this corresponds to the object height. Even the object width is preferably known.

The tilts and thus the module viewing zones 16a-c can thus namely be directly aligned on the object 34 to cover the object 34 ideally and in particular with a maximum overlap and thus to record with maximum focus, resolution, and/or speed depending on what the application requires.

In FIG. 9a, it is known that the object 34 is located at a relatively near distance. The camera modules 10a-c are tilted a great deal to detect the object 34 in its full width without gaps and in the depth of field range.

In FIG. 9b, in contrast, it is known that the object 34, that is also considerably wider here, is at a far distance. It is still ideally detected by a correspondingly smaller tilt.

In a further development that is not shown, a more complex object contour having locally different distances from the camera can also be detected or, alternatively, a plurality of objects of different geometries are recorded simultaneously. For this purpose, zones of the object contour or of the objects are formed that can be recorded with the same focus setting. The camera modules 10a-b are now focused zone-wise and their module viewing zones 16a-c are aligned toward the associated zone. FIGS. 8 and 9 can then be understood as a part view of that part selection of camera modules 10a-b that are responsible for a zone.

An additional sensor can be used to detect the focal position or the object geometry. A simple height can already be measured using a light barrier or a light grid; more complex geometries using a laser scanner or a 3D camera. In applications at conveyor belts, such a sensor is typically arranged upstream. The geometry information is transmitted to the camera and is associated via the conveyor belt speed.

A detection of three-dimensional image data is also possible using the camera 100, either with a second system upstream or, with a correspondingly fast detection of three-dimensional image data and a short response time of the tilting unit 20 in comparison with the dynamics in the scenery, also by a single camera 100 that uses the three-dimensional image data for an optimization of its own module viewing zones 16a-c. Three-dimensional image data also do not necessarily have to be used for the setting of module viewing zones 16a-c, but are also the sought detection parameters per se depending on the application.

The camera 100 can detect three-dimensional image data in accordance with the stereoscopic principle from the overlapping shots of at least two camera modules. Alternatively, a camera module 10 having a suitable illumination module 50 can be further developed to form a time of flight module. The illumination module 50 then generates a modulated light signal and the time of flight module determines the time of flight and thus a distance value from the modulation using a phase method or a pulse method.

Camera modules 10, illumination modules 50, especially also with a structured or modulated illumination, were presented in the previous embodiments. Further modules are conceivable, for example a target laser module that displays the monitored zone 30, module viewing zones 16, or a reading field within the monitored zone as a laser point, a cross, or another pattern or a visual feedback module that makes the set focal position or a detection result visible, for instance by a red or green light in accordance with a code that is not read or a code that is successfully read (NoRead/GoodRead).

1. A modular camera apparatus comprising:
a common control and evaluation unit and
at least one camera module, the at least one camera module having a reception optics and an image sensor that determine a module viewing zone of the camera module, wherein the module viewing zones together produce a monitored zone of the modular camera apparatus, and wherein the monitored zone is adaptable by a common setting of the module viewing zones.

2. The modular camera apparatus in accordance with claim 1,
wherein the camera module has a tilting unit for changing the direction of view.

3. The modular camera apparatus in accordance with claim 2,
wherein the tilting unit has one of a liquid lens and a voice coil actuator.

4. The modular camera apparatus in accordance with claim 1,
wherein the image sensors of the camera modules are arranged in a common plane.

5. The modular camera apparatus in accordance with claim 1,
wherein the camera module has a focus adjustment unit.

6. The modular camera apparatus in accordance with claim 1,
wherein the control and evaluation unit is configured to set the module viewing zones.

7. The modular camera apparatus in accordance with claim 6,
wherein the control and evaluation unit is configured to set an overlap of the module viewing zones in dependence on a focal position.

8. The modular camera apparatus in accordance with claim 1,
wherein the control and evaluation unit is configured to set the module viewing zones in dependence on the geometry of an object to be detected.

9. The modular camera apparatus in accordance with claim 1,
wherein the control and evaluation unit is configured to detect three-dimensional images with the aid of the camera modules and to derive a working distance therefrom for which the module viewing zones are set.

10. The modular camera apparatus in accordance with claim 1,
wherein the camera modules form at least one linear arrangement that is connected to the control and evaluation unit in a serial connection.

11. The modular camera apparatus in accordance with claim 1,
that has at least one illumination module.

12. The modular camera apparatus in accordance with claim 1,
that has at least one projection module.

13. A method for the optical detection of a monitored zone that is composed of module viewing zones of a plurality of camera modules that are each determined by a reception optics and an image sensor of the camera modules, in which method
the monitored zone is adapted by a common setting of the module viewing zones.
